(19) United States
(12) Patent Application Publication
(10) Pub. No.: US 2008/0274628 A1
(43) Pub. Date: Nov. 6, 2008

(54) Arrangement for Securely Connecting an Electronic Device to at Least Two Other Electronic Devices

(75) Inventors: Eric Chauvelier, Le Mesnil Saint Denis (FR); Frederic Marche, Bailleau Armenonville (FR); Jean-Claude Mollet, Garches (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Renault S.A.S., Baulogne Billancourt (FR)

(21) Appl. No.: 11/915,161

(22) PCT Filed: May 10, 2006
(86) PCT No.: PCT/FR2006/050426

§ 371 Date: Nov. 21, 2007

(30) Foreign Application Priority Data
May 23, 2005 (FR) 0551327

(51) Int. Cl. H01R 33/00

(52) U.S. Cl. 439/34

(57) ABSTRACT

An arrangement for connecting an accessory to a power source and to an electronic device of a vehicle. The arrangement includes: a power connector connecting the accessory to the power source, a signal connector connecting the accessory with the electronic device of the vehicle, a locking mechanism locking the power connector in position, and a locking mechanism locking the signal connector in position. The power connector lock and the signal connector lock are configured such that the signal connector can only be locked in the connected position after the power connector has been locked in the mounted position. The arrangement is suitable, for example, for an electric power steering device.

The invention proposes an arrangement for the electric connection of a motor vehicle accessory, in particular an electric power-assisted steering device, to a power source and to at least one other electronic device of the vehicle, making it possible to limit the risks of disconnection.

The invention more particularly proposes an arrangement for the electric connection of a motor vehicle accessory to an electric power source and to at least one electronic device of the vehicle, of the type that comprises a power connector that is able to be mounted on the accessory in a connected position, for the connection of the accessory to the electric power source, a signal connector that is able to be mounted on the accessory in a connected position, for the connection of the accessory with said electronic device of the vehicle, means for locking the power connector in the connected position to the accessory, and means for locking the signal connector in the connected position to the accessory.

Such an arrangement is used in particular for the electric connection of the power-assisted steering device of a motor vehicle to the battery of the vehicle, on the one hand, and to one or more sensors arranged in the vehicle, on the other hand.

According to a known embodiment, the mounting and locking of the power connector and of the signal connector are systematically inspected by an operator. However, inspections made by a human being are sometimes incorrect.

It is therefore possible that, on certain vehicles, the power connector is not locked in the connected position, and consequently the power connector may disconnect at any moment from the power-assisted steering device.

Such a disconnection of the power connector causes the power-assisted steering device to stop and the driver must then provide a greater effort to operate the steering of the vehicle.

The disconnection of the power connector may be particularly inconvenient for the driver of the vehicle, and it may lead to a dangerous situation, particularly when it occurs when the vehicle is moving.

There are many arrangements for the connection of the power-assisted steering device that make it possible to simplify the mounting and locking of the connectors; such arrangements are described for example in documents U.S. Pat. No. 6,707,185 and U.S. Pat. No. 5,844,386.

However, such arrangements do not make it possible to improve the reliability of the locking of the connectors in the mounted position.

The object of the invention is to propose an arrangement for the electric connection of the power-assisted steering device making it possible to obtain in a certain manner the locking of the power connector.

For this purpose, the invention proposes an arrangement of the type described above, characterized in that the means for locking the power connector and the means for locking the signal connector are conformed so that the signal connector can be locked in the connected position only after the power connector is locked in the mounted position.

According to other features of the invention:
the power connector, the means for locking the power connector and the means for locking the signal connector are conformed so that the power connector can be mounted on the accessory only before the signal connector is mounted on the accessory;
the means for locking the power connector comprise a lug that is able to interact with a matching lug of the means for locking the signal connector;
the means for locking the power connector are supported by the signal connector;
the means for locking the signal connector are conformed so as to prevent the power connector being mounted after the signal connector is mounted and locked in the connected position;
the accessory is a motor vehicle electronic power-assisted steering device.

Other features and advantages of the invention will appear on reading the following detailed description for the understanding of which reference should be made to the appended figures in which:

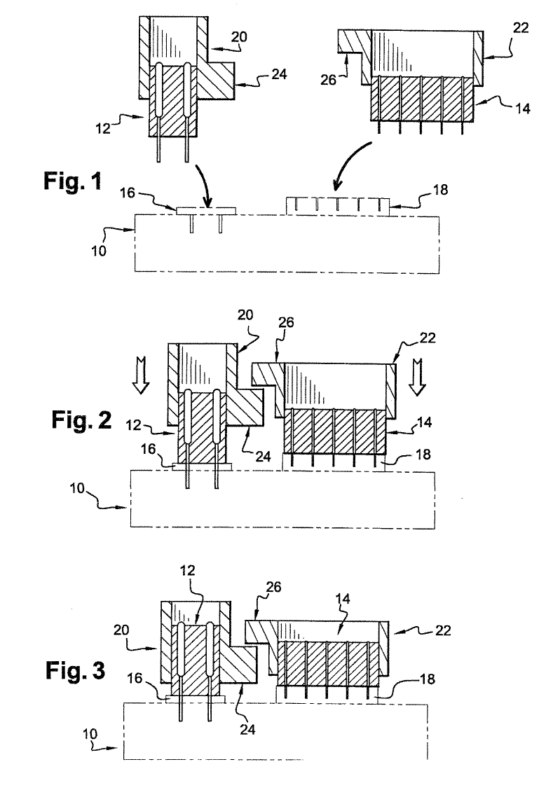

FIG. 1 is a schematic representation of the arrangement according to the invention in which the power connector and the signal connector are in a position disconnected from the accessory,

FIG. 2 is a view similar to that of FIG. 1, in which the connectors are in the position connected to the accessory, but are not locked in this position,

FIG. 3 is a view similar to that of FIG. 2 in which the connectors are in the position connected to the accessory, and are locked in this connected position.

The figures show a motor vehicle accessory 10, which consists for example in an electric power-assisted steering device of the vehicle.

Conventionally, the power-assisted steering device 10 comprises an actuator (not shown) which acts on the steering system of the vehicle to reduce the forces that the driver must provide on the vehicle steering wheel and an electronic command device (not shown) in order to determine which action must be performed by the actuator, according to various operating parameters of the vehicle, such as for example its speed of movement.

The power-assisted steering device 10 is supplied with electric power originating from an electric power source, particularly from the battery of the vehicle (not shown), and its electronic command device is electrically connected to one or more electronic devices of the vehicle (not shown), such as for example speed sensors and steering wheel position sensors, in order to receive information relating to the operating parameters of the vehicle.

The power-assisted steering device 10 is connected to the electric power source by means of a first connector 12 that will hereafter be called the “power connector”, and the power-assisted steering device 10 is connected to the electronic devices of the vehicle by means of a second connector 14, that will hereafter be called the “signal connector”.

The power connector 12 is able to be mounted on a matching recess 16, or equivalent, of the power-assisted steering device 10 in a connected position in which the power-assisted steering device 10 is connected to the battery of the vehicle.

Similarly, the signal connector 14 is able to be mounted on a matching recess 18, or equivalent, of the power-assisted steering device 10 in a connected position in which the power-assisted steering device 10 is connected to the electronic devices of the vehicle.

The power-assisted steering device 10 is subjected to many vibrations that may cause the connectors 12, 14 to disconnect from the power-assisted steering device 10.

To prevent the power connector 12 and the signal connector 14 being disconnected from the power-assisted steering device 10, the power connector 12 and the signal connector 14 each comprise means 20, 22 for locking them in the connected position.

Here, each of the means 20 for locking the power connector 12 and the means 22 for locking the signal connector 14 consists generally of a ring mounted so as to slide vertically from top to bottom relative to the power connector 12 or relative to the signal connector 14, respectively, with reference to the figures.

However, it will be understood that this embodiment of the means 20 for locking the power connector 12 and the means 22 for locking the signal connector 14 is described only as an illustration and that the invention is not limited solely to these locking means.

For example, in a known manner, the signal connector 14 and its locking means 22 comprise a system called an “ejection spring system” which prevents the signal connector 14 from being able to remain in the connected position if its locking means 22 are not in the locked position.

According to the invention, the means 20 for locking the power connector 12 are conformed so as to interact with the means 22 for locking the signal connector 14 so that the signal connector 14 can be locked in its connected position only after the power connector 12 is locked in its connected position.

Therefore, as can be seen in FIG. 2, when the means 20 for locking the power connector 12 are not in their locked position, the means 22 for locking the signal connector 14 cannot be moved to their position for locking the signal connector 14 in the connected position.

In addition, when the signal connector 14 and its locking means 22 comprise the system of the “ejection spring” type mentioned above, the signal connector 14 cannot remain in the connected position if the means 20 for locking the power connector 12 are not in the locked position.

According to a variant embodiment, the power-assisted steering device comprises means for detecting the position of the means 22 for locking the signal connector 14 and that transmit an item of information relating to the signal connector 14 being locked or not locked to a diagnostic device of the vehicle.

According to another aspect of the invention, the means 22 for locking the signal connector 14 are conformed so as to prevent the power connector 12 being mounted after the signal connector 14 is mounted and locked in the connected position on the associated recess 18.

In such a case, since the power connector 12 cannot be mounted on the associated recess 16, the power-assisted steering device 10 cannot operate and such a mounting defect of the power connector 12 may then be detected immediately on the assembly line of the vehicle, even before the vehicle is put on the road.

According to the invention, the locking means 20 of the power connector 12 comprise a first lug 24 that is able to interact with a second lug 26 supported by the means 22 for locking the signal connector 14.

As can be seen in FIG. 2, the lugs 24, 26 are conformed so that, when the means 20 for locking the power connector 12 are in a position other than their position for locking the power connector 12, the second lug 26 is butting against the first lug 24, thereby preventing the means 22 for locking the signal connector 14 from being moved to their locked position.

On the other hand, as can be seen in FIG. 3, when the means 20 for locking the power connector 12 are in their position for locking the power connector 12, the second lug 26 is no longer butting against the first lug 24; the means 22 for locking the signal connector 14 may then be moved to their locked position.

According to a variant embodiment of the invention (not shown), the means 20 for locking the power connector 12 are conformed so as to prevent the signal connector 14 being mounted on the associated recess 18 of the power-assisted steering device 10, when they are in a position other than their position for locking the power connector 12 in the connected position.

According to this variant embodiment of the invention, the second lug 26 is supported by the signal connector 14, and as has been described above, the second lug 26 is butting against the first lug 24 when the means 20 for locking the power connector 12 are in a position other than their position for locking the power connector 12 in the connected position.

According to another variant embodiment of the invention (not shown), the means 20 for locking the power connector 12 are supported by the signal connector 14 and are conformed so that the power connector 12 is locked before or at the same time as the signal connector 14 is locked.

According to a preferred embodiment of this other variant of the invention, the means 22 for locking the signal connector 14 form the means 20 for locking the power connector 12.

Consequently, the power connector 12 is locked at the same time as the signal connector 14 is locked.

An arrangement of the means 20, 22 for locking the power connector 12 and the signal connector 14 according to the invention makes it possible to immediately detect the incorrect locking of the power connector 12 when the signal connector 14 is not locked.

Specifically, when the power connector 12 is in the connected position on the associated recess 16, but is not locked in this position, the second lug 26 comes to butt against the first lug 24 when the signal connector 14 is locked, which prevents the signal connector 14 from being locked.

The means for detecting the position of the means 22 for locking the signal connector 14 then give a first item of information relating to the absence of the locking of the signal connector 14 and consequently the absence of the locking of the power connector 12.

In addition, when the signal connector 14 and the associated locking means 22 comprise the “ejection spring” system, and when the power connector 22 is not locked in the connected position, the “ejection spring” system causes the disconnection of the signal connector 14 since it cannot be locked in the connected position. The power-assisted steering device 10 cannot then function.

Finally, when the power connector 12 has not been connected before the signal connector 14, as has been described above, the second lug 26 prevents the power connector 12 from being mounted on the associated recess 16. The power-assisted steering device 10 cannot then function.

When the power-assisted steering device 10 cannot function because the power connector 12 or the signal connector 14 are not in the connected position and are not locked in the connected position, such a failure is easily detectable and may be repaired before the vehicle is put on the road.

The invention that has just been described is applied in association with an electronic power-assisted steering device 10. However, it will be understood that the invention is not limited to this application, and that it may be applied to other electronic accessories of a motor vehicle that comprise an electric power supply circuit and a circuit for transmitting at least one electronic signal, such as for example an airbag.

1-6. (canceled)

7. An arrangement for electrical connection of a motor vehicle accessory to an electric power source and to at least one electronic device of the vehicle, comprising:
a power connector configured to be mounted on the accessory in a connected position, for connection of the accessory to the electric power source;
a signal connector configured to be mounted on the accessory in a connected position, for connection of the accessory with the electronic device of the vehicle;
means for locking the power connector in the connected position to the accessory; and
means for locking the signal connector in the connected position to the accessory;
wherein the means for locking the power connector and the means for locking the signal connector are configured so that the signal connector can be locked in the connected position only after the power connector is locked in the mounted position.

8. The arrangement as claimed in claim 7, wherein the power connector, the means for locking the power connector, and the means for locking the signal connector are configured so that the power connector can be mounted on the accessory only before the signal connector is mounted on the accessory.

9. The arrangement as claimed in claim 7, wherein the means for locking the power connector comprises a lug configured to interact with a matching lug of the means for locking the signal connector.

10. The arrangement as claimed in claim 7, wherein the means for locking the power connector is supported by the signal connector.

11. The arrangement as claimed in claim 7, wherein the means for locking the signal connector is configured to prevent the power connector from being mounted after the signal connector is mounted and locked in the connected position.

12. The arrangement as claimed in claim 7, wherein the accessory is a motor vehicle electronic power-assisted steering device.
